(19) United States
(12) Patent Application Publication
(10) Pub. No.: US 2010/0091012 A1
(43) Pub. Date: Apr. 15, 2010

(54) 3 MENU DISPLAY

(75) Inventors: Philip S. Newton, Eindhoven (NL); Hong Li, Eindhoven (NL); Darwin He, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/442,722

(22) PCT Filed: Sep. 21, 2007
(86) PCT No.: PCT/IB2007/053840

§ 371 Date: Dec. 22, 2009

(30) Foreign Application Priority Data
Sep. 28, 2006 (EP) 06121421.9

(51) Int. Cl. G06T 15/00

(52) U.S. Cl. 345/419

(57) ABSTRACT

A device and method of rendering visual information combine image information like video and secondary image information, like graphics. The image information and the secondary image information are processed for generating output information to be rendered in a three-dimensional space. The output information is arranged for display on a 3D stereoscopic display having a true display depth range (44). The processing includes detecting an image depth range of the image information, and detecting a secondary depth range of the secondary visual information. In the display depth range (44), a first sub-range (41) and second sub-range (43) are determined, which first sub-range and second sub-range are non-overlapping. The image depth range is accommodated in the first sub-range and the secondary depth range is accommodated in the second sub-range. Advantageously graphics and video are displayed in true 3D without video objects occluding graphical objects.

### FIELD OF THE INVENTION

The invention relates to a method of rendering visual information, which method comprises receiving image information, receiving secondary image information to be rendered in combination with the image information, processing the image information and the secondary image information for generating output information to be rendered in a three-dimensional space.

The invention further relates to a device for rendering visual information, the device comprising input means for receiving image information, and receiving secondary image information to be rendered in combination with the image information, and processing means for processing the image information and the secondary image information for generating output information to be rendered in a three-dimensional space.

The invention further relates to a computer program product for rendering visual information.

The invention relates to the field of rendering image information on three-dimensional [3D] displays, for example video on auto-stereoscopic devices like multi-lenticular devices.

### BACKGROUND OF THE INVENTION

Document US 2006/0031776 describes a multi-planar three-dimensional user interface. Graphical elements are displayed in a three dimensional space. Use of the three dimensional space increases the capability to display content items and allows the user interface to move unselected items out of primary view of the user. Image information items may be displayed on different planes in the space, and may overlap. It is to be noted that the document discusses displaying a tree dimensional space on a 2 dimensional display screen.

Currently various 3D display systems are being developed for providing a real 3D effect including a perceived display depth range for the user, like multi-lenticular display devices or 3D beamer systems. The multi-lenticular display has a surface of tiny lenses, each covering a few pixels. The user will receive different images in each eye. The beamer systems require the user to wear glasses that alternatingly cover the eyes, in synchronism with different images being projected on the screen.

### SUMMARY OF THE INVENTION

The document US 2006/0031776 provides examples of displaying items on planes in a virtual three dimensional space rendered on two dimensional display screens. However, the document does not discuss the options of real depth 3D display systems, and displaying various image information elements on such display systems.

It is an object of the invention to provide a method and device for rendering a combination of image information of various types on 3D display systems.

For this purpose, according to a first aspect of the invention, in the method as described in the opening paragraph, the output information is arranged for display on a 3D display having a display depth range, and the processing comprises detecting an image depth range of the image information, detecting a secondary depth range of the secondary visual information, determining, in the display depth range, a first sub-range and second sub-range, which first sub-range and second sub-range are non-overlapping, and accommodating the image depth range in the first sub-range and accommodating the secondary depth range in the second sub-range.

For this purpose, according to a second aspect of the invention, in the device as described in the opening paragraph, the processing means is arranged for generating the output information for display on a 3D display having a display depth range, detecting an image depth range of the image information, detecting a secondary depth range of the secondary visual information, determining, in the display depth range, a first sub-range and second sub-range, which first sub-range and second sub-range are non-overlapping, and accommodating the image depth range in the first sub-range and accommodating the secondary depth range in the second sub-range.

The measures have the effect that each set of image information is assigned it's own, separate depth range. Because the first and second depth ranges do not overlap, occlusion of elements in the image data located in a front (second) depth range by protruding elements of a more backward (first) depth sub-range is prevented. Advantageously the user is not confused by intermingling of 3D objects of various image sources.

The invention is also based on the following recognition. Displaying 3D image information of various sources may be required on a single 3D display system. The inventors have seen that, as various elements have different depths, a combined image on a display might be confusing to a user. For example, some elements of a video application in the background may move forward and unexpectedly (partly) occlude graphical elements located on a more forward position. For some applications such overlap may be predictable, and a suitable depth position for various elements may be adjusted while authoring such content. However, the inventors have seen that in many situations a combination is to be displayed that is unpredictable. Determining the sub-ranges for combined display, and assigning a non-overlapping sub-range to each source, avoids confusing mix-up of elements of different sources at different depths.

In an embodiment of the method said accommodating comprises compressing the image depth range to fit in the first sub-range, and/or compressing the secondary depth range to fit in the second sub-range. This has the advantage that the original image information depth information is converted into the available sub-range, while maintaining the original depth structure for each set of image information in a reduced range.

In an embodiment of the method the output information includes image data and a depth map for positioning the image data along the depth dimension of the 3D display according to depth values, and the method comprises determining, in the depth map, a first sub-range of depth values and second sub-range of depth values as the first sub-range and the second sub-range. This has the advantage that the sub-ranges can be easily mapped onto respective value ranges in the depth map.

Further preferred embodiments of the device and method according to the invention are given in the appended claims, disclosure of which is incorporated herein by reference.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 shows an example of a 2D image and depth map,

FIG. 2 shows an example of the four planes in a video format,

FIG. 3 shows an example of a composite image created using four planes,

FIG. 4 shows rendering graphics and video with compressed depth, and

FIG. 5 shows a system for rendering 3D visual information.

In the Figures, elements which correspond to elements already described have the same reference numerals.

### DETAILED DESCRIPTION OF EMBODIMENTS

The following section provides an overview of three-dimensional [3D] displays and perception of depth by humans. 3D displays differ from 2D displays in the sense that they can provide a more vivid perception of depth. This is achieved because they provide more depth cues then 2D displays which can only show monocular depth cues and cues based on motion.

Monocular (or static) depth cues can be obtained from a static image using a single eye. Painters often use monocular cues to create a sense of depth in their paintings. These cues include relative size, height relative to the horizon, occlusion, perspective, texture gradients, and lighting/shadows. Oculomotor cues are depth cues derived from tension in the muscles of a viewers eyes. The eyes have muscles for rotating the eyes as well as for stretching the eye lens. The stretching and relaxing of the eye lens is called accommodation and is done when focusing on a image. The amount of stretching or relaxing of the lens muscles provides a cue for how far or close an object is. Rotation of the eyes is done such that both eyes focus on the same object, which is called convergence. Finally motion parallax is the effect that objects close to a viewer appear to move faster then objects further away.

Binocular disparity is a depth cue which is derived from the fact that both our eyes see a slightly different image. Monocular depth cues can be and are used in any 2D visual display type. To re-create binocular disparity in a display requires that the display can segment the view for the left—and right eye such that each sees a slightly different image on the display. Displays that can re-create binocular disparity are special displays which we will refer to as 3D or stereoscopic displays. The 3D displays are able to display images along a depth dimension actually perceived by the human eyes, called a 3D display having display depth range in this document. Hence 3D displays provide a different view to the left- and right eye.

3D displays which can provide two different views have been around for a long time. Most of these were based on using glasses to separate the left- and right eye view. Now with the advancement of display technology new displays have entered the market which can provide a stereo view without using glasses. These displays are called auto-stereoscopic displays.

A first approach is based on LCD displays that allow the user to see stereo video without glasses. These are based on either of two techniques, the lenticular screen and the barrier displays. With the lenticular display, the LCD is covered by a sheet of lenticular lenses. These lenses diffract the light from the display such that the left- and right eye receive light from different pixels. This allows two different images one for the left- and one for the right eye view to be displayed.

An alternative to the lenticular screen is the Barrier display, which uses a parallax barrier behind the LCD and in front the backlight to separate the light from pixels in the LCD. The barrier is such that from a set position in front of the screen, the left eye sees different pixels then the right eye. A problem with the barrier display is loss in brightness and resolution but also a very narrow viewing angle. This makes it less attractive as a living room TV compared to the lenticular screen, which for example has 9 views and multiple viewing zones.

A further approach is still based on using shutter-glasses in combination with high-resolution beamers that can display frames at a high refresh rate (e.g. 120 Hz). The high refresh rate is required because with the shutter glasses method the left and right eye view are alternately displayed. For the viewer wearing the glasses perceives stereo video at 60 Hz. The shutter-glasses method allows for a high quality video and great level of depth.

The auto stereoscopic displays and the shutter glasses method do both suffer from accommodation-convergence mismatch. This does limit the amount of depth and the time that can be comfortable viewed using these devices. There are other display technologies, such as holographic- and volumetric displays, which do not suffer from this problem. It is noted that the current invention may be used for any type of 3D display that has a depth range.

Image data for the 3D displays is assumed to be available as electronic, usually digital, data. The current invention relates to such image data and manipulates the image data in the digital domain. The image data, when transferred from a source, may already contain 3D information, e.g. by using dual cameras, or a dedicated preprocessing system may be involved to (re-)create the 3D information from 2D images. Image data may be static like slides, or may include moving video like movies. Other image data, usually called graphical data, may be available as stored objects or generated on the fly as required by an application. For example user control information like menus, navigation items or text and help annotations may be added to other image data.

There are many different ways in which stereo images may be formatted, called a 3D image format. Some formats are based on using the bandwidth in a 2D channel to also carry the stereo information. For example the left and right view can be interlaced or can be placed side by side and above and under. These methods sacrifice resolution to carry the stereo information. Another option is to sacrifice color, this approach is called anaglyphic stereo. Anaglyphic stereo uses spectral multiplexing which is based on displaying two separate, overlaid images in complementary colors. By using glasses with colored filters each eye only sees the image of the same color as of the filter in front of that eye. So for example the right eye only sees the red image and the left eye only the green image.

A different 3D format is based on two views using a 2D image and an additional depth image, a so called depth map, which conveys information about the depth of objects in the 2D image.

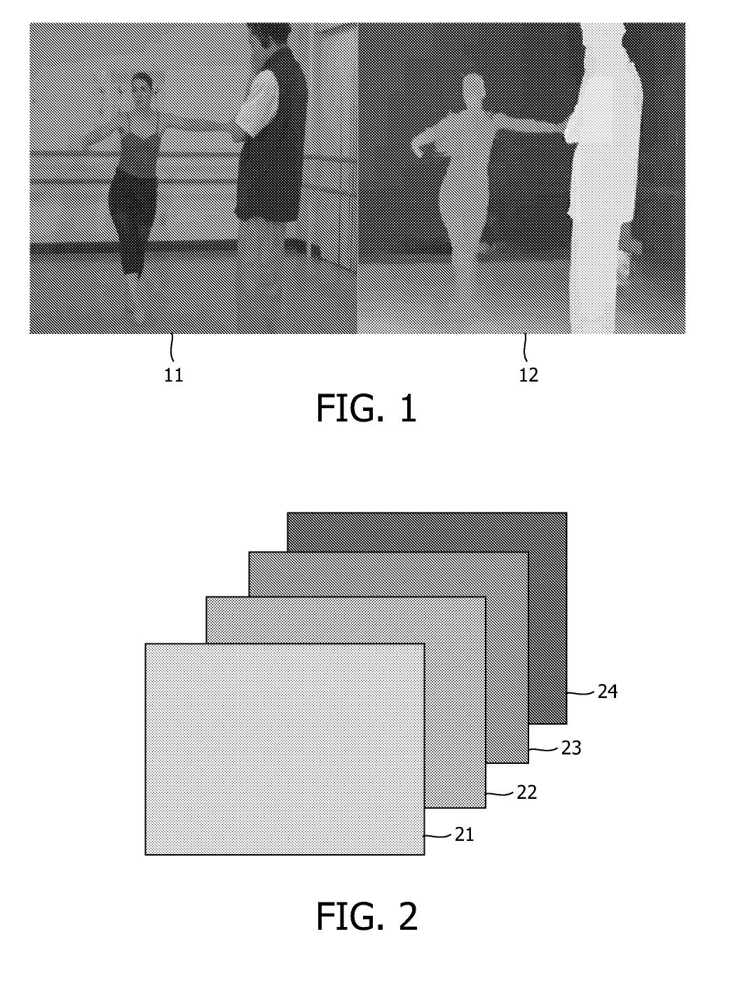

FIG. 1 shows an example of a 2D image and depth map. The left image is a 2D image 11, usually in color, and the right image is a depth map 12. The 2D image information may be represented in any suitable image format. The depth map information may be an additional data stream having a depth value for each pixel, possibly at a reduced resolution compared to the 2D image. In the depth map grey scale values indicate the depth of the associated pixel in the 2D image. White indicates close to the viewer, and black indicates a large depth far from the viewer. A 3D display can calculate the additional view required for stereo by using the depth value from the depth map and by calculating required pixel transformations. Occlusions may be solved using estimation or hole filling techniques.

Adding stereo to video also impacts the format of the video when it is sent from a player device, such as a Blu-ray disc player, to a stereo display. In the 2D case only a 2D video stream is sent (decoded picture data). With stereo video this increases as now a second stream must be sent containing the second view (for stereo) or a depth map. This could double the required bitrate on the electrical interface. A different approach is to sacrifice resolution and format the stream such that the second view or the depth map are interlaced or placed side by side with the 2D video. FIG. 1 shows an example of how this could be done for transmitting 2D data and a depth map. When overlaying graphics on video, further separate data streams may be used.

A 3D publishing format should provide not only video but also graphics for subtitles, menu's and games. Combining 3D video with graphics requires particular attention as just placing a 2D menu on top of a 3D video background may not be sufficient. Objects in the video may overlap the 2D graphics items creating very strange effects and diminishing the 3D perception.

FIG. 2 shows an example of the four planes in a video format. The four planes are intended for use on a 2D display using transparency, e.g. based on the BluRay disc format. Alternatively the planes may be displayed in a depth range of a 3D display. A first plane 21 is positioned closest to the viewer, and is assigned to display interactive graphics. A second plane 22 is assigned to display presentation graphics like subtitles, a third plane 23 is assigned to display video, whereas a fourth plane 24 is a background plane. The four planes are available in a BluRay disc player; a DVD player has three planes. A content author can overlay graphics for a menu, subtitles, and video on top of a background image.

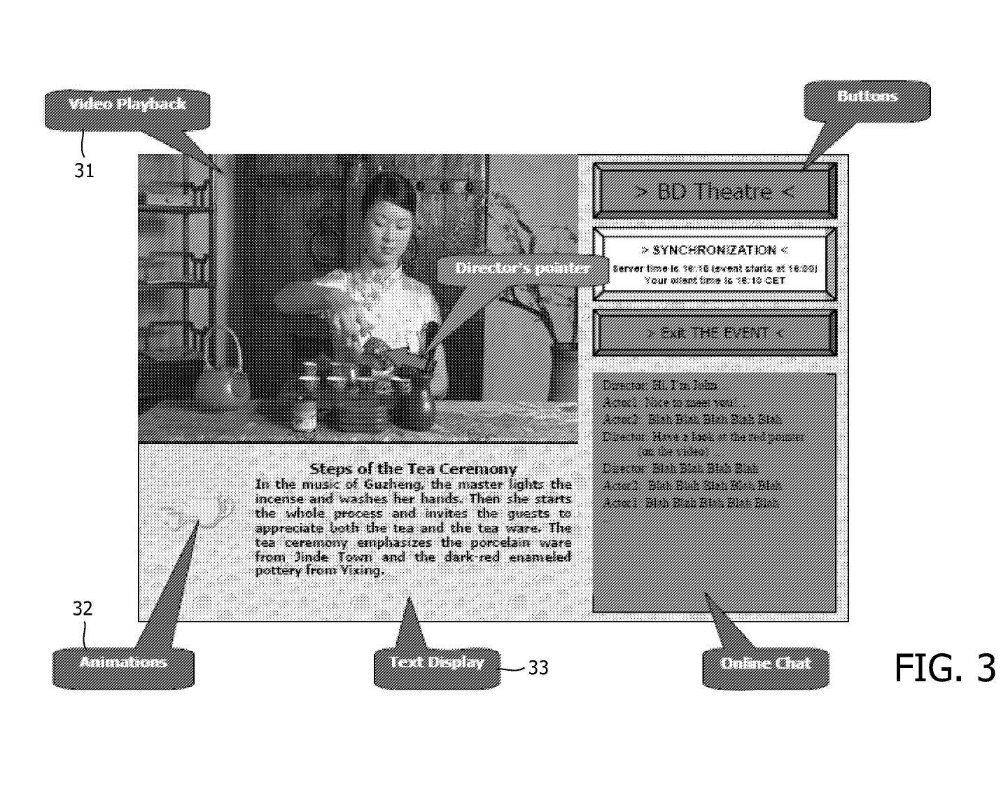

FIG. 3 shows an example of a composite image created using four planes. The concept of four places is explained above with FIG. 2. FIG. 3 shows some interactive graphics 32 on the first plane 21, some text 33 displayed on the second plane 22, and some video 31 on the third plane 23. A problem occurs when all of these planes would have an added third dimension. The third dimension “depth” would have to be shared amongst the four planes. Also objects in one plane could protrude objects on another plane. Some items, for example text, may remain in 2D. It is assumed that for subtitles the presentation graphics plane will remain 2 dimensional. That in itself causes another problem as combining 2D objects in a 3D scene can cause strange effects when parts of the 3D image overlap the 2D image, i.e. when parts of a 3D object are closer to the viewer then the 2D object. To overcome this problem the 2D text is placed in front of the 3D video at a set distance from the front of the display, a set depth.

However, the graphics will be in 2D and/or 3D. This means that objects in the graphics plane may overlap and appear behind or in front of the 3D video in the background. Also objects in the moving video may suddenly appear in front of the graphics occluding for example a menu item.

A system for rendering 3D image information based on a combination of various image elements is arranged as follows. First the system receives image information, and secondary image information, to be rendered in combination with the image information. For example the various image elements may be received from a single source like an optical record carrier, via the internet, or from several sources (e.g. a video stream from a hard disk and locally generated 3D graphical objects, or a separate 3D enhancement stream via a network). The system processes the image information and the secondary image information for generating output information to be rendered in a three-dimensional space on a 3D display which has a display depth range.

The processing for rendering the combination of various image elements includes the following steps. An image depth range of the image information is detected first, for example by detecting a 3D format of the image information and retrieving a corresponding image depth range parameter. Also a secondary depth range of the secondary visual information is detected, e.g. a graphics depth range parameter. Subsequently the display depth range is subdivided into a few sub-ranges, according to a number of image information sets to be rendered together. For example, for displaying two 3D image information sets, a first sub-range and second sub-range are selected. To obviated problems with overlapping 3D objects the first sub-range and second sub-range are set to be non-overlapping. Subsequently the image depth range is rendered in the first sub-range and the secondary depth range is rendered in the second sub-range. For accommodating the 3D image information in the respective sub-ranges, the depth information in the respective image data streams is adjusted to fit in the respective selected sub-ranges. For example video information constituting the main image information is shifted backwards, while graphic information constituting the secondary information is shifted forward, until any overlap is prevented. It is noted that the processing step may combine the various image information sets to a single output stream, or that the output data may have different image data streams. However the depth information has been adjusted such that no overlap in the depth direction occurs.

In an embodiment of the processing said accommodating includes compressing the main image depth range to fit in the first sub-range, and/or compressing the secondary depth range to fit in the second sub-range. It is noted that the original depth ranges of the main and/or secondary image information may be larger than the available sub-ranges. If so, some depth values may be clipped to the maximum or minimum of the respective range. Preferably the original image depth range is converted into the sub-range, e.g. by linearly compressing the depth range to fit in. Alternatively a selected compression may be applied, e.g. maintaining the front end substantially uncompressed and increasingly compressing the depth further down.

The image information and secondary image information may include different video streams, static image data, predefined graphics, animated graphics, etc. In an embodiment the image information is video information and the secondary image information is graphics, and said compressing includes moving the video depth range backwards to make room for the second sub-range for rendering the graphics.

In an embodiment the output information is according to a 3D format that includes image data and a depth map, as explained above with FIG. 1. The depth map has depth values for positioning the image data along the depth dimension of the 3D display. For adjusting the image information into the selected sub-ranges, the processing includes determining, in the depth map, a first sub-range of depth values and second sub-range of depth values as the first sub-range and the second sub-range. Subsequently the image data is compressed to cover only the respective sub-range of depth values. In addition the 2D image information may be included as separate streams to be overlaid, or may already be combined to a single 2D image stream. Furthermore some occlusion information may be added to the output information in order to enable calculating various views in the display device.

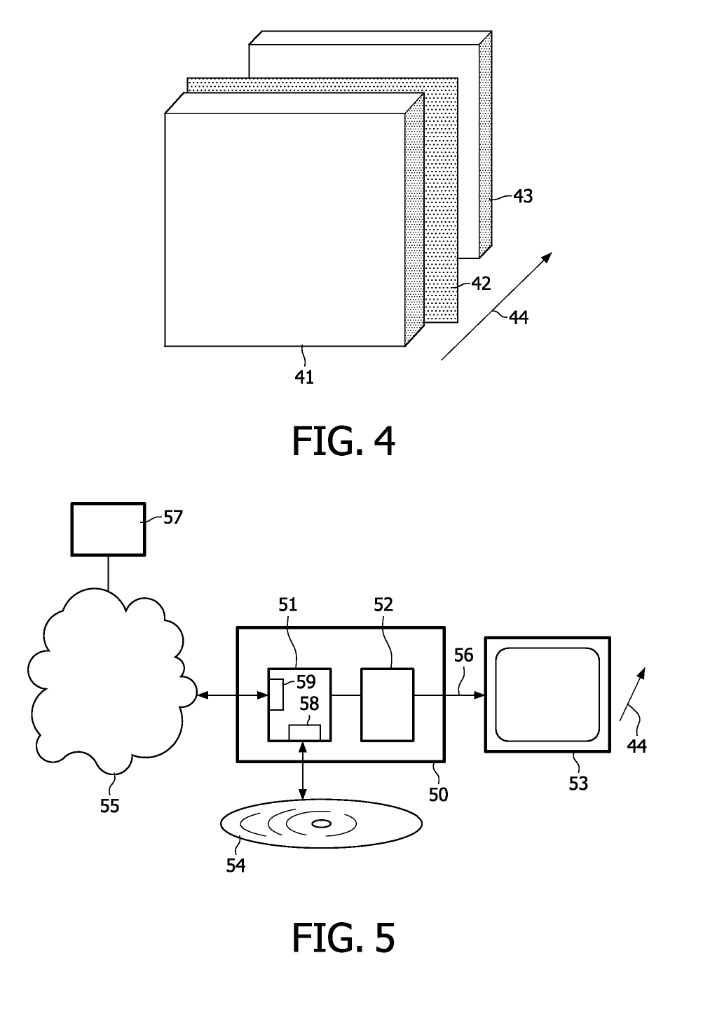

FIG. 4 shows rendering graphics and video with compressed depth. The

Figure schematically shows a 3D display having a display depth range indicated by arrow 44. A backward sub-range 43 is assigned to render video as main image information, having a video depth range in the backward part of the total display depth range. A front sub-range 41 is assigned to render graphics as secondary image information, having a secondary depth in the forward part of the total display depth range. The image display front surface 42 indicates the actual plane where the various (auto-)stereoscopic images are generated.

In an embodiment the processing includes determining, in the display depth range, a third sub-range, which is non-overlapping with the first sub-range and second sub-range, for displaying additional image information. As can be seen in FIG. 4 a third level may be located around the image display front surface 42. In particular the additional information may be two-dimensional information for rendering on a plane in the third sub-range, for example text. Obviously the forward images should at least partly be transparent to allow viewing the video in sub-range 43.

It is noted that for image information that is authored, the adjusting of the various depth ranges may be accomplished during authoring. For example for combining graphics and video this can be solved by carefully aligning the depth profiles of the graphics and the video. These graphics are rendered on a presentation graphics plane and depth range that does not overlap with the video range. However for interactive graphics such as menu's this is more difficult as it is unknown beforehand where and when the graphics will appear in the video.

In an embodiment said receiving the secondary image information includes receiving a trigger for generating graphical objects having a depth property when rendered. A trigger may be generated by a program or application, e.g. a game or interactive show. Also the user may active a button on a remote control unit and a menu or graphical animation is to be rendered while the video continues. The processing for said accommodating now includes adjusting a process of generating the graphical objects. The process is adjusted such that the depth property of the graphical object fit in the selected sub-range of the display.

The accommodating of image data to separate sub-ranges may occur for a period starting or ending with trigger events, e.g. for a predetermined period after the user presses a button. At the same time the depth range of the video may be adjusted or compressed as indicated above to create the free depth range. Hence, the processing may detect a period in which no secondary information is to be rendered, and, in the detected period, accommodate the image depth range in the display depth range. The depth range of the image dynamically changes when further objects need to be rendered and request a free depth sub-range.

In a practical embodiment the system automatically compresses the depth of the video plane and moves the video plane backwards such to make room for more depth perception in the graphics plane. The graphics plane is positioned such that objects do appear to come—out of the screen. This puts more attention to the graphics and de-emphasizes the video in the background. Making it easier for the user to navigate the graphics which are normally intended for a menu (or more generic a User-Interface) Also it preserves as much creative freedom as possible for content authors as both the video and the graphics are still in 3D and they together utilize the maximum depth range of the display.

A disadvantage is that placing the video further behind the screen may cause viewer discomfort if experienced for a longer period of time. However interactive tasks in such a system usually are quite short so this should not pose a big problem. The discomfort is caused by problems relating to differences between convergence and accommodation. Convergence is positioning of the two eyes to look at one object, accommodation is adjusting the eye lens to focus on an object such that the image appears sharp on the retina

In an embodiment the processing includes filtering the image information, or filtering the secondary image information, for increasing a visual difference between the image information and the secondary information. By placing a filter over the video content, the above mentioned eye discomfort may be reduced. For example the contrast or brightness of the video may be reduced. In particular the level of details may be reduced by filtering higher spatial frequencies of the video, resulting in a blurring of the video image. The eye will then naturally focus on the graphics of the menu and not on the video. It reduces eye-strain as the menu is positioned near the front of the display. An additional benefit is that this improves user performance in navigating the menu. Alternatively the secondary information, e.g. graphics in front, may be made less visible, e.g. by blurring or increasing the transparency.

FIG. 5 shows a system for rendering 3D visual information. A rendering device 50 is coupled to a stereoscopic display 53, also called 3D display, having a display depth range indicated by arrow 44. The device has an input unit 51 for receiving image information, and receiving secondary image information to be rendered in combination with the image information. For example the input unit device may include an optical disc unit 58 for retrieving various types of image information from an optical record carrier 54 like a DVD or BluRay disc enhanced to contain 3D image data. Furthermore, the input unit may include a network interface unit 59 for coupling to a network 55, for example the internet. 3D image information may be retrieved from a remote media server 57. The device has a processing unit 52 coupled to the input unit 51 for processing the image information and the secondary image information for generating output information 56 to be rendered in a three-dimensional space. The processing unit 52 is arranged for generating the output information 56 for display on the 3D display 53. The processing further includes detecting an image depth range of the image information, and detecting a secondary depth range of the secondary visual information. In the display depth range, a first sub-range and second sub-range are determined, which first sub-range and second sub-range are non-overlapping. Subsequently the image depth range is accommodated in the first sub-range and the secondary depth range is accommodated in the second sub-range, as explained above.

It is to be noted that the invention may be implemented in hardware and/or software, using programmable components. A method for implementing the invention has the processing steps as explained for the system with reference to FIGS. 3 and 4. A computer program may have software function for the respective processing steps, and may be implemented on a personal computer or on a dedicated video system. Although the invention has been mainly explained by embodiments using optical record carriers or the internet, the invention is also suitable for any image processing environment, like authoring software or broadcasting equipment. Further applications include a 3D personal computer [PC] user interface or 3D media center PC, a 3D mobile player and a 3D mobile phone.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software, and a processor may fulfill the function of one or more units, possibly in cooperation with hardware elements. Further, the invention is not limited to the embodiments, and the invention lies in each and every novel feature or combination of features described above.

1. Method of rendering visual information, which method comprises receiving image information,
receiving secondary image information to be rendered in combination with the image information, and
processing the image information and the secondary image information for generating output information to be rendered in a three-dimensional space,
the output information being arranged for display on a 3D display (53) having a display depth range (44), and the processing comprising
detecting an image depth range of the image information,
detecting a secondary depth range of the secondary visual information,
determining, in the display depth range, a first sub-range (43) and second sub-range (41), which first sub-range and second sub-range are non-overlapping, and
accommodating the image depth range in the first sub-range and accommodating the secondary depth range in the second sub-range.

2. Method as claimed in claim 1, wherein said accommodating comprises compressing the image depth range to fit in the first sub-range, and/or compressing the secondary depth range to fit in the second sub-range.

3. Method as claimed in claim 1, wherein the output information includes image data and a depth map for positioning the image data along the depth dimension of the 3D display according to depth values, and the method comprises determining, in the depth map, a first sub-range of depth values and second sub-range of depth values as the first sub-range and the second sub-range.

4. Method as claimed in claim 1, wherein said receiving the secondary image information comprises receiving a trigger for generating graphical objects having a depth property when rendered, and the accommodating comprises adjusting generating the graphical objects to fit the depth property in the second sub-range.

5. Method as claimed in claim 1, wherein the method comprises detecting a period in which no secondary information is to be rendered, and, in the detected period, accommodating the image depth range in the display depth range.

6. Method as claimed in claim 1, wherein the method comprises filtering the image information, or filtering the secondary image information, for increasing a visual difference between the image information and the secondary image information.

7. Method as claimed in claim 1, wherein the method comprises determining, in the display depth range, a third sub-range, which is non-overlapping with the first sub-range and second sub-range, for displaying additional image information, in a particular case the additional information being two dimensional information to be rendered on a plane in the third sub-range.

8. Method as claimed in claim 2, wherein the image information is video information and the secondary image information is graphics, and said compressing includes moving the video depth range backwards to make room for the second sub-range for rendering the graphics.

9. Device for rendering visual information, the device comprising input means (51) for
receiving image information, and
receiving secondary image information to be rendered in combination with the image information, and
processing means (52) for processing the image information and the secondary image information for generating output information (56) to be rendered in a three-dimensional space,
the processing means being arranged for
generating the output information for display on a 3D display (53) having a display depth range (44),
detecting an image depth range of the image information,
detecting a secondary depth range of the secondary visual information,
determining, in the display depth range, a first sub-range (43) and second sub-range (41), which first sub-range and second sub-range are non-overlapping, and
accommodating the image depth range in the first sub-range and accommodating the secondary depth range in the second sub-range.

10. Device as claimed in claim 9, wherein the input means (51) comprises an optical disc unit (58) for retrieving the image information from an optical disc.

11. Device as claimed in claim 9, wherein the device comprises the 3D display (53) for displaying the image information in combination with the secondary image information along the display depth range.

12. Computer program product for rendering visual information, which program is operative to cause a processor to perform the method as claimed in claim 8.
